(19) United States
(12) Patent Application Publication
(10) Pub. No.: US 2025/0266852 A1
(43) Pub. Date: Aug. 21, 2025

(54) RADIO FREQUENCY CIRCUIT

(71) Applicant: Murata Manufacturing Co., Ltd., Nagaokakyo-shi (JP)

(72) Inventors: Hirotsugu MORI, Nagaokakyo-shi (JP); Morio TAKEUCHI, Nagaokakyo-shi (JP)

(73) Assignee: Murata Manufacturing Co., Ltd., Nagaokakyo-shi (JP)

(21) Appl. No.: 19/183,944

(22) Filed: Apr. 21, 2025

Related U.S. Application Data
(63) Continuation of application No. PCT/JP2023/027628, filed on Jul. 27, 2023.

(30) Foreign Application Priority Data
Nov. 17, 2022 (JP) 2022-183885

(51) Int. Cl. H04B 1/00; H04B 1/40

(52) U.S. Cl. CPC H04B 1/006; H04B 1/0067; H04B 1/40

(57) ABSTRACT

A radio frequency circuit includes: a first filter having a passband including a first frequency band that is at least one of a transmission band or a receiving band of a first Non-Terrestrial Network (NTN) band; a second filter having a passband including a second frequency band that is at least one of a transmission band or a receiving band of a second NTN band; a third filter having a passband including a third frequency band that is at least one of a transmission band or a receiving band of a first Terrestrial Network (TN) band; and a first switch that includes a first terminal connected to an antenna connection terminal, a second terminal connected to the first and second filters, and a third terminal connected to the third filter. The third frequency band at least partially overlaps a frequency gap between the first and second frequency bands.

### CROSS-REFERENCE TO RELATED APPLICATIONS

This is a continuation application of PCT International Application No. PCT/JP2023/027628 filed on Jul. 27, 2023, designating the United States of America, which is based on and claims priority to Japanese Patent Application No. 2022-183885 filed on Nov. 17, 2022. The entire disclosures of the above-identified applications, including the specifications, drawings and claims are incorporated herein by reference in their entirety.

### TECHNICAL FIELD

The present disclosure relates to a radio frequency circuit.

### BACKGROUND

The 3rd Generation Partnership Project (3GPP (registered trademark)) has been examining integration of Terrestrial Networks (TNs) into Non-Terrestrial Networks (NTNs) and standardizing the NTNs.

### SUMMARY

### Technical Problems

However, as recognized by the present inventor, there are concerns with conventional radio frequency circuits disclosed by, for instance, US Patent Application Publication No. 2015/0133067, such as an increase in the size of a communication device and/or deterioration of characteristics, in a case in which TNs and NTNs are both supported.

In view of this, the present disclosure provides a radio frequency circuit that can support both TNs and NTNs and contribute to reduction in the size of a communication device and/or improvement of properties.

### Solutions

A radio frequency circuit according to an aspect of the present disclosure includes: a first filter having a passband that includes a first frequency band that is at least one of a transmission band or a receiving band of a first Non-Terrestrial Network (NTN) band; a second filter having a passband that includes a second frequency band that is at least one of a transmission band or a receiving band of a second NTN band; a third filter having a passband that includes a third frequency band that is at least one of a transmission band or a receiving band of a first Terrestrial Network (TN) band; and a first switch that includes a first terminal connected to an antenna connection terminal, a second terminal connected to the first filter and the second filter, and a third terminal connected to the third filter. The third frequency band at least partially overlaps a frequency gap between the first frequency band and the second frequency band.

A radio frequency circuit according to an aspect of the present disclosure includes: a first filter having a passband that includes a first frequency band that is a transmission band of a Non-Terrestrial Network (NTN) band; a second filter having a passband that includes a second frequency band that is a receiving band of the NTN band; a third filter having a passband that includes a third frequency band that is at least one of a transmission band or a receiving band of a Terrestrial Network (TN) band; and a switch that includes a first terminal connected to an antenna connection terminal, a second terminal connected to the first filter and the second filter, and a third terminal connected to the third filter. The third frequency band at least partially overlaps a frequency gap between the first frequency band and the second frequency band.

### Advantageous Effects

According to a radio frequency circuit, it is possible to support both TNs and NTNs and contribute to reduction in the size of a communication device and/or improvement of characteristics.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 illustrates a circuit configuration of a communication device according to Embodiment 1.

FIG. 2 illustrates Non-Terrestrial Network (NTN) bands and Terrestrial Network (TN) bands.

FIG. 3A illustrates frequency characteristics of filters for NTN bands according to Embodiment 1.

FIG. 3B illustrates frequency characteristics of filters for TN bands according to Embodiment 1.

FIG. 4 illustrates a circuit configuration of a communication device according to Embodiment 2.

FIG. 5 illustrates a circuit configuration of a communication device according to Embodiment 3.

### DESCRIPTION OF EMBODIMENTS

The following describes in detail embodiments of the present disclosure, with reference to the drawings. Note that the embodiments described below each show a general or specific example. The numerical values, shapes, materials, elements, and the arrangement and connection of the elements, for instance, described in the following embodiments are examples, and thus are not intended to limit the present disclosure.

Note that the drawings are schematic diagrams to which emphasis, omission, and ratio adjustment are appropriately added in order to illustrate the present disclosure, and thus are not necessarily accurate illustrations. The drawings may show shapes, positional relations, and ratios that are different from actual shapes, actual positional relations, and actual ratios. Throughout the drawings, the same numeral is given to substantially the same element, and redundant description may be omitted or simplified.

In the circuit configuration of the present disclosure, “being connected” includes not only the case of being directly connected by a connection terminal and/or a line conductor, but also the case of being electrically connected via another circuit element. “Being connected between A and B” means being connected between A and B and to both A and B, and means being connected in series onto a path that connects A and B. A “terminal” means a point at which a conductor in an element ends. Note that under a condition that an impedance of a conductor between elements is sufficiently low, a terminal can be interpreted not only as a single fixed point, but as any point on the conductor between the elements or as the entire conductor.

In the present disclosure, Terrestrial Network (TN) bands and Non-Terrestrial Network (NTN) bands are frequency bands for TNs and NTNs, which are established using radio access technology (RAT) and are predefined by, for instance, standardizing bodies (such as the 3GPP and the Institute of Electrical and Electronics Engineers (IEEE), for example).

In the present disclosure, a “frequency gap between Band A and Band B” means a range between the highest frequency in Band A (that is, the high-frequency edge of Band A) and the lowest frequency in Band B (that is, the low-frequency edge of Band B) under a condition that Band A has a range of frequencies lower than the frequencies of the range of Band B. At this time, the high-frequency edge of Band A is lower than the low-frequency edge of Band B. The expression “Band C at least partially overlaps a frequency gap” means there is an overlapping portion between Band C and the frequency gap. At this time, the overlapping portion may be a band edge only. Thus, the expression “Band C at least partially overlaps a frequency gap” includes the high-frequency edge of Band C matching the low-frequency edge of the frequency gap and the low-frequency edge of Band C matching the high-frequency edge of the frequency gap.

In the present disclosure, a “transmission band” means a frequency band used for transmission in a communication device. For example, a frequency band different from the receiving band is used as a transmission band in a Frequency Division Duplex (FDD) band. On the other hand, a frequency band the same as the receiving band is used as a transmission band in a Time Division Duplex (TDD) band. In particular, in a case in which a communication device functions as a user equipment (UE) for TNs or NTNs, an uplink operation band is used as a transmission band in an FDD band. Conversely, in a case in which a communication device functions as a base station (BS) for TNs or NTNs, the downlink operation band is used as the transmission band in an FDD band.

In the present disclosure, “a passband of a filter” is defined as a frequency band which is a portion of a frequency spectrum of a signal transferred by a filter and in which an output power is not attenuated from a maximum output power by 3 dB or more.

### Embodiment 1

Embodiment 1 is to be described. Communication device 5 according to the present embodiment functions as a user equipment (UE) in Terrestrial Networks (TNs) and Non-Terrestrial Networks (NTNs), and typically is a mobile phone, a smartphone, a tablet computer, or a wearable device, for instance. Note that communication device 5 may be an Internet of Things (IoT) sensor/device, a medical/health care device, a vehicle, an unmanned aerial vehicle (UAV) (a so-called drone), or an automated guided vehicle (AGV). Communication device 5 may function as a base station (BS) in TNs and NTNs.

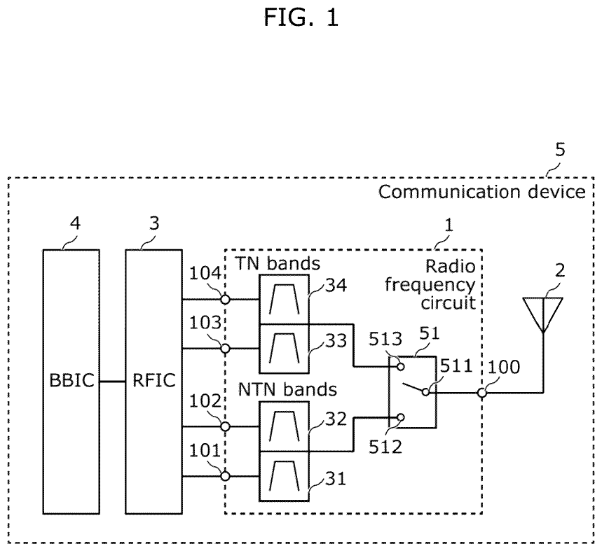

A circuit configuration of communication device 5 and radio frequency circuit 1 according to the present embodiment is to be described with reference to FIG. 1. FIG. 1 illustrates a circuit configuration of communication device 5 according to the present embodiment.

Note that FIG. 1 illustrates an exemplary circuit configuration, and communication device 5 and radio frequency circuit 1 may be implemented using any of various types of circuit implementations and circuit technologies. Thus, the description of communication device 5 and radio frequency circuit 1 provided below should not be interpreted in a limited manner.

### [1.1 Circuit Configuration of Communication Device 5]

First, a circuit configuration of communication device 5 according to the present embodiment is to be described with reference to FIG. 1. Communication device 5 includes radio frequency circuit 1, antenna 2, radio frequency integrated circuit (RFIC) 3, and baseband integrated circuit (BBIC) 4.

Radio frequency circuit 1 transfers radio frequency signals between antenna 2 and RFIC 3. A circuit configuration of radio frequency circuit 1 is to be described later.

Antenna 2 is connected to antenna connection terminal 100 of radio frequency circuit 1. Antenna 2 receives radio frequency signals from radio frequency circuit 1 and outputs the radio frequency signals to the outside of communication device 5. Antenna 2 receives radio frequency signals from the outside of communication device 5 and outputs the radio frequency signals to radio frequency circuit 1. Note that antenna 2 may not be included in communication device 5. Communication device 5 may further include one or more antennas in addition to antenna 2.

RFIC 3 is an example of a signal processing circuit that processes radio frequency signals. Specifically, RFIC 3 processes transmission signals input from BBIC 4 by, for instance, up-conversion, and outputs radio frequency transmission signals generated by processing the transmission signals to radio frequency circuit 1. Furthermore, RFIC 3 processes radio frequency received signals input through a reception path of radio frequency circuit 1 by down-conversion, for instance, and outputs received signals generated by processing the radio frequency received signals to BBIC 4. RFIC 3 may include a controller configured to control, for instance, a switch and a power amplifier that are included in radio frequency circuit 1. Note that the controller may be partially or entirely provided outside of RFIC 3 and may be partially or entirely provided in BBIC 4 or radio frequency circuit 1, for example.

BBIC 4 is a base band signal processing circuit that processes signals using an intermediate frequency band lower than the frequency of a radio frequency signal transferred by radio frequency circuit 1. A signal processed by BBIC 4 is used, for example, as an image signal for image display or as an audio signal for talk through a loudspeaker. Note that BBIC 4 may not be included in communication device 5.

### [1.2 Circuit Configuration of Radio Frequency Circuit 1]

Next, a circuit configuration of radio frequency circuit 1 according to the present embodiment is to be described with reference to FIG. 1. Radio frequency circuit 1 includes filters 31 to 34, switch 51, antenna connection terminal 100, and input-output terminals 101 to 104.

Antenna connection terminal 100 is an external connection terminal of radio frequency circuit 1 and is connected to antenna 2 outside radio frequency circuit 1. Antenna connection terminal 100 is connected to switch 51 inside radio frequency circuit 1. Accordingly, radio frequency circuit 1 can supply transmission signals to antenna 2 via antenna connection terminal 100, and can be supplied with received signals from antenna 2 via antenna connection terminal 100.

Input-output terminals 101 to 104 are external connection terminals of radio frequency circuit 1 and are connected to RFIC 3 outside radio frequency circuit 1. Input-output terminals 101 to 104 are connected to filters 31 to 34 inside radio frequency circuit 1, respectively. Accordingly, input-output terminals 101 to 104 can receive radio frequency signals from RFIC 3 and/or can supply radio frequency signals to RFIC 3.

Filter 31 is an example of a first filter, and has a passband that includes a first frequency band. Filter 31 is connected between input-output terminal 101 and terminal 512 of switch 51. As the first frequency band, one of the transmission band or the receiving band of a first NTN band can be used.

Filter 32 is an example of a second filter, and has a passband that includes a second frequency band. Filter 32 is connected between input-output terminal 102 and terminal 512 of switch 51. Accordingly, filter 32 is connected to the same terminal as the terminal to which filter 31 is connected. As the second frequency band, a remaining one of the transmission band or the receiving band of the first NTN band or one of the transmission band or the receiving band of a second NTN band can be used.

Filter 33 is an example of a third filter, and has a passband that includes a third frequency band. Filter 33 is connected between input-output terminal 103 and terminal 513 of switch 51. Accordingly, filter 33 is connected to a terminal different from the terminal to which filters 31 and 32 are connected. As the third frequency band, at least one of the transmission band or the receiving band of a first TN band can be used.

Filter 34 is an example of a fourth filter, and has a passband that includes a fourth frequency band. Filter 34 is connected between input-output terminal 104 and terminal 513 of switch 51. Accordingly, filter 34 is connected to a terminal different from the terminal to which filters 31 and 32 are connected and is connected to the same terminal as the terminal to which filter 33 is connected. As the fourth frequency band, at least one of the transmission band or the receiving band of a second TN band can be used. Note that filter 34 may not be included in radio frequency circuit 1.

A surface acoustic wave (SAW) filter, a bulk acoustic wave (BAW) filter, an inductor-capacitor (LC) resonator filter, a dielectric resonator filter, or a combination of any of these may be used as each of such filters 31 to 34, and furthermore, filters 31 to 34 are not limited to these.

Switch 51 is an example of a first switch, and is connected between antenna connection terminal 100 and filters 31 to 34. Specifically, switch 51 includes terminals 511 to 513. Terminal 511 is an example of a first terminal, and is connected to antenna connection terminal 100. Terminal 512 is an example of a second terminal, and is connected to filters 31 and 32. Terminal 513 is an example of a third terminal, and is connected to filters 33 and 34.

With this connection configuration, switch 51 can connect terminal 511 exclusively to terminal 512 or can connect terminal 511 exclusively to terminal 513, based on a control signal from RFIC 3, for example. Stated differently, terminal 511 is prohibited from being simultaneously connected to terminals 512 and 513 in switch 51. Switch 51 includes a single-pole double-throw (SPDT) switch circuit, for example.

Switch 51 may be mounted on a semiconductor integrated circuit that includes a plurality of metal-oxide-semiconductor field-effect transistors (MOSFETs), for example. Note that the method for mounting switch 51 is not limited thereto.

### [1.3 Description of First to Fourth Frequency Bands]

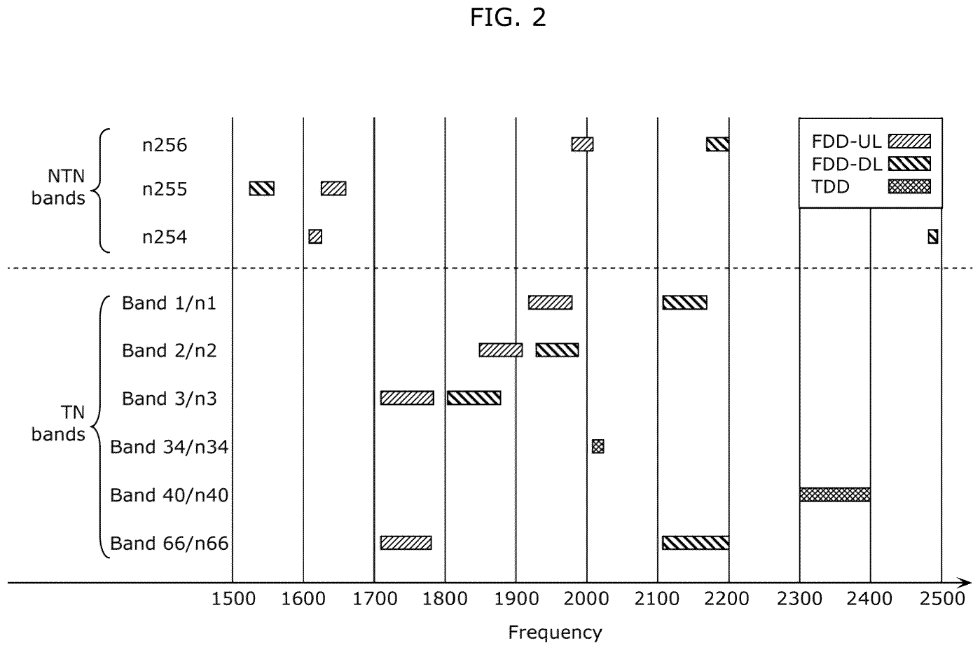

Here, the first to fourth frequency bands that can be used in the present embodiment are to be described with reference to FIG. 2. FIG. 2 illustrates frequency bands that can be used in the present embodiment. In FIG. 2, the vertical axis shows band names, and the horizontal axis shows frequencies (MHZ).

The first to fourth frequency bands satisfy the following conditions. Note that in a case in which radio frequency circuit 1 does not include filter 34, (4) and (5) are not included in the conditions. (1) The first frequency band is included in the first NTN band. (2) The second frequency band is included in the first NTN band or the second NTN band. (3) The third frequency band is included in the first TN band and at least partially overlaps the frequency gap between the first frequency band and the second frequency band. (4) The fourth frequency band is included in the first TN band or the second TN band and at least partially overlaps the frequency gap between the first frequency band and the second frequency band. (5) The frequency gap between the first frequency band and the second frequency band is wider than the frequency gap between the third frequency band and the fourth frequency band.

As combinations of the first to fourth frequency bands that satisfy (1) to (5) stated above, combinations stated in Table 1 shown below can be used, for example. In the following, “n” represents a band for 5th Generation New Radio (5G NR), whereas “Band” represents a band for Long Term Evolution (LTE). The numerical values following “n” and “Band” represent numbers for identifying bands. Tx represents transmission in FDD bands, Rx represents reception in FDD bands, and TRx represents transmission and reception in TDD bands.

TABLE 1

| | First freq. | Second freq. | Third freq. | Fourth freq. |
|---|---|---|---|---|
| No. | band | band | band | band |
| 1 | n256-Tx/Rx | n255-Tx/Rx | Band 1/n1-Tx | Band 3/n3-Tx/Rx |
| 2 | or | or | Band 2/n2-Tx/Rx | Band 66/n66-Tx |
| 3 | n254-Rx | n254-Tx | Band 2/n2-Tx | Band 2/n2-Rx |
| 4 | | | Band 3/n3-Tx | Band 3/n3-Rx |
| 5 | n256-Rx | | Band 1/n1-Tx | Band 1/n1-Rx |
| 6 | or | | Band 1/n1-Rx | Band 3/n3-Tx/Rx |
| 7 | n254-Rx | | Band 1/n1-Tx/Rx | Band 34/n34-TRx |
| 8 | | | Band 3/n3-Tx/Rx | Band 34/n34-TRx |
| 9 | | | Band 2/n2-Tx/Rx | Band 66/n66-Rx |
| 10 | | | Band 66/n66-Tx | |
| 11 | n254-Rx | | Band 1/n1-Tx/Rx | Band 40/n40-TRx |
| 12 | | | Band 3/n3-Tx/Rx | |
| 13 | | | Band 34/n34-TRx | |
| 14 | n256-Rx | n256-Tx | Band 1/n1-Rx | Band 34/n34-TRx |
| 15 | | | Band 66-Rx | — |

For example, according to No. 1 of the combinations, the transmission band or the receiving band of n256 or the receiving band of n254 is used as the first frequency band, and the transmission band or the receiving band of n255 or the transmission band of n254 is used as the second frequency band. At this time, the transmission band of Band 1 or n1 is used as the third frequency band, and the transmission band or the receiving band of Band 3 or n3 is used as the fourth frequency band.

Note that the first frequency band and the second frequency band can be interchanged with each other, and the third frequency band and the fourth frequency band can also be interchanged with each other. FDD bands are used as NTN bands, but TDD bands may be used. In this case, transmission-receiving bands of TDD bands may be used as the first frequency band and/or the second frequency band.

### [1.4 Filter Characteristics]

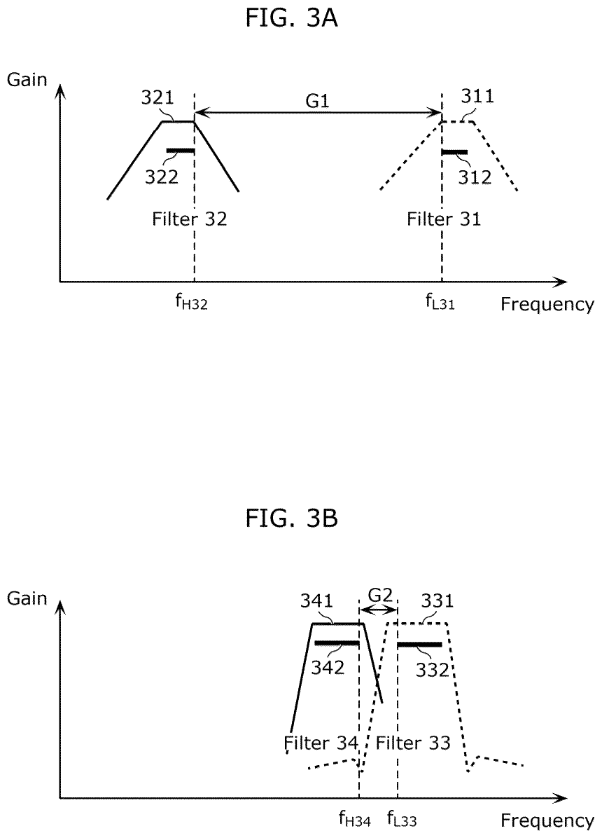

Filter characteristics of filters 31 to 34 having passbands that include the first frequency band to the fourth frequency band are to be described with reference to FIG. 3A and FIG. 3B. FIG. 3A illustrates frequency characteristics of filters 31 and 32 for NTN bands according to the present embodiment. FIG. 3B illustrates frequency characteristics of filters 33 and 34 for TN bands according to the present embodiment. In FIG. 3A and FIG. 3B, the horizontal axis represents frequency, and the vertical axis represents gain.

FIG. 3A illustrates frequency characteristics 311 of filter 31 and frequency characteristics 321 of filter 32. In frequency characteristics 311, the passband of filter 31 includes first frequency band 312. In frequency characteristics 321, the passband of filter 32 includes second frequency band 322.

FIG. 3B illustrates frequency characteristics 331 of filter 33 and frequency characteristics 341 of filter 34. In frequency characteristics 331, the passband of filter 33 includes first frequency band 332. In frequency characteristics 341, the passband of filter 34 includes second frequency band 342.

Note that in FIG. 3A, frequency gap G1 between first frequency band 312 and second frequency band 322 is defined by low-frequency edge f_{L31} of the first frequency band and high-frequency edge f_{H32} of the second frequency band. In FIG. 3B, frequency gap G2 between third frequency band 332 and fourth frequency band 342 is defined by low-frequency edge f_{L33} of the third frequency band and high-frequency edge f_{H34} of the fourth frequency band. Frequency gap G1 thus defined is wider than frequency gap G2. Thus, the steepness of attenuation characteristics on the lower frequency side of filter 31 can be made less than the steepness of attenuation characteristics on the lower frequency side of filter 33. Similarly, the steepness of attenuation characteristics on the higher frequency side of filter 32 can be made less than the steepness of attenuation characteristics on the higher frequency side of filter 34.

[1.5 Advantageous effects and others]

As described above, radio frequency circuit 1 according to the present embodiment includes: filter 31 having a passband that includes a first frequency band that is at least one of a transmission band or a receiving band of a first Non-Terrestrial Network (NTN) band; filter 32 having a passband that includes a second frequency band that is at least one of a transmission band or a receiving band of a second NTN band; filter 33 having a passband that includes a third frequency band that is at least one of a transmission band or a receiving band of a first Terrestrial Network (TN) band; and switch 51 that includes terminal 511 connected to antenna connection terminal 100, terminal 512 connected to filter 31 and filter 32, and terminal 513 connected to filter 33. The third frequency band at least partially overlaps a frequency gap between the first frequency band and the second frequency band.

According to this, terminal 513 of switch 51 to which filter 33 for the first TN band is connected is different from terminal 512 of switch 51 to which filters 31 and 32 for the first NTN band and the second NTN band are connected. Thus, switch 51 can ensure the isolation of filters 31 and 32 from filter 33. As a result, the need for attenuation in the third frequency band included in the first TN band can be reduced in filters 31 and 32, and resistance loss of filters 31 and 32 can be decreased and/or the sizes of filters 31 and 32 can be reduced. In particular, the frequency gap between bands is wider in an NTN than in a TN. Thus, since the need for attenuation in the third frequency band that at least partially overlaps the frequency gap between the first frequency band and the second frequency band is reduced, steepness of attenuation characteristics at passband edges of filters 31 and 32 can be made less, which is effective in reducing resistance loss and sizes of filters 31 and 32.

For example, in radio frequency circuit 1 according to the present embodiment, switch 51 may be configured to connect terminal 511 exclusively to terminal 512 or to connect terminal 511 exclusively to terminal 513.

According to this, the isolation between (i) filters 31 and 32 connected to terminal 512 and (ii) filter 33 connected to terminal 513 can be effectively ensured, and resistance loss and sizes of filters 31 and 32 can be more effectively reduced.

For example, in radio frequency circuit 1 according to the present embodiment, the first frequency band may be the transmission band of the first NTN band, the second frequency band may be the transmission band of the second NTN band, and the third frequency band may be the transmission band of the first TN band.

According to this, radio frequency circuit 1 can support transmission of radio frequency signals in NTNs and TNs.

For example, in radio frequency circuit 1 according to the present embodiment, the first NTN band may be n256 for 5th Generation New Radio (5G NR), the second NTN band may be n255 or n254 for 5G NR, and the first TN band may be Band 1 for Long Term Evolution (LTE) or n1 for 5G NR.

According to this, radio frequency circuit 1 can use n256 for 5G NR and n255 or n254 for 5G NR to transmit radio frequency signals in NTNs, and can use Band 1 for LTE or n1 for 5G NR to transmit radio frequency signals in TNs.

For example, radio frequency circuit 1 according to the present embodiment may further include: filter 34 connected to terminal 513 of switch 51 and having a passband that includes a fourth frequency band that is at least one of a transmission band or a receiving band of a second TN band. The fourth frequency band may at least partially overlap the frequency gap between the first frequency band and the second frequency band, and the frequency gap between the first frequency band and the second frequency band may be wider than a frequency gap between the third frequency band and the fourth frequency band.

According to this, filter 34 for the second TN band is connected to terminal 513 of switch 51. Thus, switch 51 can ensure the isolation of filters 31 and 32 from filter 34, and radio frequency circuit 1 can further support the second TN band and can reduce resistance loss of filters 31 and 32 and/or the sizes of filters 31 and 32.

For example, in radio frequency circuit 1 according to the present embodiment, the fourth frequency band may be the receiving band of the second TN band.

According to this, radio frequency circuit 1 can support reception of radio frequency signals in TNs.

For example, in radio frequency circuit 1 according to the present embodiment, the first NTN band may be n256 for 5th Generation New Radio (5G NR), the second NTN band may be n255 or n254 for 5G NR, the first TN band may be Band 1 for Long Term Evolution (LTE) or n1 for 5G NR, and the second TN band may be Band 3 for LTE or n3 for 5G NR.

According to this, radio frequency circuit 1 can use n256 for 5G NR and n255 or n254 for 5G NR to transmit radio frequency signals in NTNs, whereas in TNs, radio frequency circuit 1 can use Band 1 for LTE or n1 for 5G NR to transmit radio frequency signals and can use Band 3 for LTE or n3 for 5G NR to receive radio frequency signals.

For example, in radio frequency circuit 1 according to the present embodiment, the first frequency band may be the transmission band of the first NTN band, the second frequency band may be the transmission band of the second NTN band, and the third frequency band may be the receiving band of the first TN band.

According to this, radio frequency circuit 1 can support transmission of radio frequency signals in NTNs and reception of radio frequency signals in TNs.

For example, in radio frequency circuit 1 according to the present embodiment, the first NTN band may be n256 for 5th Generation New Radio (5G NR), the second NTN band may be n255 or n254 for 5G NR, and the first TN band may be Band 3 for Long Term Evolution (LTE) or n3 for 5G NR.

According to this, radio frequency circuit 1 can use n256 for 5G NR and n255 or n254 for 5G NR to transmit radio frequency signals in

NTNs, and can use Band 3 for LTE or n3 for 5G NR to transmit radio frequency signals in TNs.

Radio frequency circuit 1 according to the present embodiment includes: filter 31 having a passband that includes a first frequency band that is a transmission band of a Non-Terrestrial Network (NTN) band; filter 32 having a passband that includes a second frequency band that is a receiving band of the NTN band; filter 33 having a passband that includes a third frequency band that is at least one of a transmission band or a receiving band of a Terrestrial Network (TN) band; and switch 51 that includes terminal 511 connected to antenna connection terminal 100, terminal 512 connected to filters 31 and 32, and terminal 513 connected to filter 33. The third frequency band at least partially overlaps a frequency gap between the first frequency band and the second frequency band.

According to this, terminal 513 of switch 51 to which filter 33 for the TN band is connected is different from terminal 512 of switch 51 to which filters 31 and 32 for the NTN band are connected. Thus, switch 51 can ensure the isolation of filters 31 and 32 from filter 33. As a result, the need for attenuation in the third frequency band included in the TN band can be reduced in filters 31 and 32, resistance loss of filters 31 and 32 and/or the sizes of filters 31 and 32 can be reduced. In particular, the frequency gap between bands is wider in an NTN than in a TN. Thus, since the need for attenuation in the third frequency band that at least partially overlaps the frequency gap between the first frequency band and the second frequency gap is reduced, steepness of attenuation characteristics at passband edges of filters 31 and 32 can be made less, which is effective in reducing resistance loss and sizes of filters 31 and 32.

For example, in radio frequency circuit 1 according to the present embodiment, the NTN band may be n256 for 5th Generation New Radio (5G NR), and the TN band may be a band selected from among Band 1, Band 34, and Band 66 for Long Term Evolution (LTE) and n1, n34, and n66 for 5G NR.

According to this, radio frequency circuit 1 can use n256 for 5G NR to transmit and receive radio frequency signals in NTNs, and can use Band 1, Band 34, or Band 66 for LTE or n1, n34, or n66 for 5G NR to transmit and/or receive radio frequency signals in TNs.

### Embodiment 2

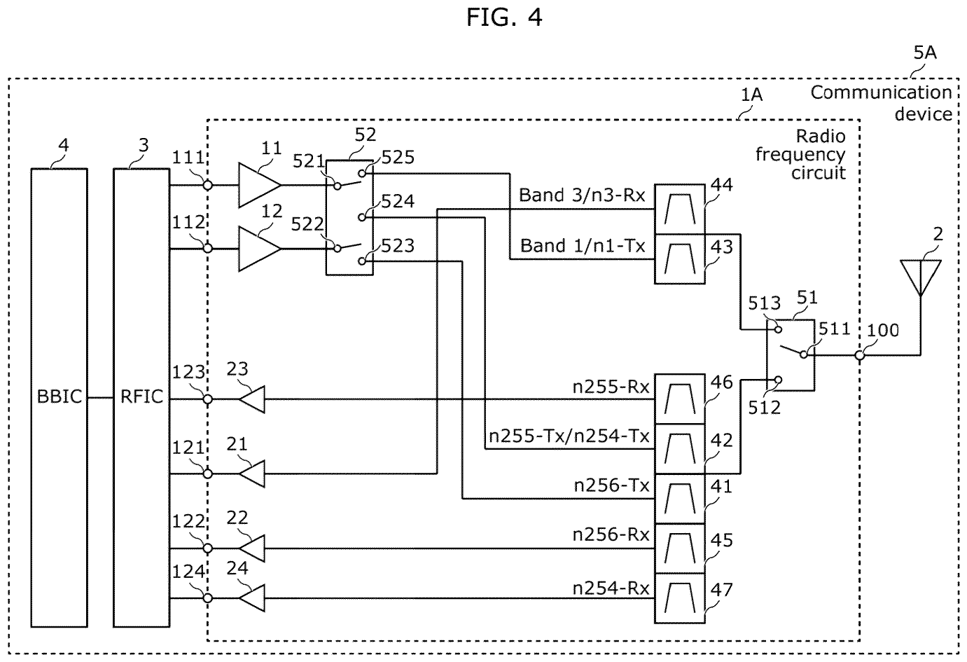

Embodiment 2 is to be described in the following. In the present embodiment, a specific example of a radio frequency circuit under a condition that No. 1 of the combinations in Table 1 is used in Embodiment 1 described above is to be described with reference to FIG. 4. FIG. 4 illustrates a circuit configuration of communication device 5A according to the present embodiment.

Note that FIG. 4 illustrates an exemplary circuit configuration, and communication device 5A and radio frequency circuit 1A may be mounted using any of various types of circuit implementations and circuit technologies. Thus, the description of communication device 5A and radio frequency circuit 1A provided below should not be interpreted in a limited manner.

Since communication device 5A according to the present embodiment is the same as communication device 5 according to Embodiment 1 except that radio frequency circuit 1A is included instead of radio frequency circuit 1, and thus description of elements of communication device 5A other than radio frequency circuit 1A is omitted.

### [2.1 Circuit Configuration of Radio Frequency Circuit 1A]

Radio frequency circuit 1A according to the present embodiment includes power amplifiers 11 and 12, low-noise amplifiers 21 to 24, filters 41 to 47, switches 51 and 52, antenna connection terminal 100, radio frequency input terminals 111 and 112, and radio frequency output terminals 121 to 124.

Radio frequency input terminals 111 and 112 are external connection terminals of radio frequency circuit 1A and can receive transmission signals from RFIC 3. Specifically, radio frequency input terminals 111 and 112 are connected to RFIC 3 outside radio frequency circuit 1A and are connected to power amplifiers 11 and 12 inside radio frequency circuit 1A, respectively.

Radio frequency output terminals 121 to 124 are external connection terminals of radio frequency circuit 1A and can supply received signals to RFIC 3. Specifically, radio frequency output terminals 121 to 124 are connected to RFIC 3 outside radio frequency circuit 1A and are connected to low-noise amplifiers 21 to 24 inside radio frequency circuit 1A, respectively.

Power amplifier 11 is an example of a first power amplifier. The input end of power amplifier 11 is connected to radio frequency input terminal 111. The output end of power amplifier 11 is connected to any one of filters 41 to 43 via switch 52. Power amplifier 11 can amplify radio frequency signals received via radio frequency input terminal 111, using power supplied from a power supply (not illustrated).

Power amplifier 12 is an example of a second power amplifier. The input end of power amplifier 12 is connected to radio frequency input terminal 112. The output end of power amplifier 12 is connected to any one of filters 41 to 43 via switch 52. Power amplifier 12 can amplify radio frequency signals received via radio frequency input terminal 112, using power supplied from a power supply (not illustrated).

Power amplifiers 11 and 12 can include heterojunction bipolar transistors (HBTs), and can be manufactured using semiconductor material. As the semiconductor material, silicon-germanium (SiGe) or gallium arsenide (GaAs) can be used, for example. Note that amplifier transistors of power amplifiers 11 and 12 are not limited to HBTs. For example, at least one of power amplifier 11 or power amplifier 12 may include a high electron mobility transistor (HEMT) or a metal-semiconductor field effect transistor (MESFET). In this case, gallium nitride (GaN) or silicon carbide (SIC) may be used as the semiconductor material.

Note that power amplifier 11 and/or power amplifier 12 may not be partially or entirely included in radio frequency circuit 1A. In this case, power amplifier 11 may be partially or entirely connected between RFIC 3 and radio frequency input terminal 111, and power amplifier 12 may be partially or entirely connected between RFIC 3 and radio frequency input terminal 112. Power amplifier 11 and/or power amplifier 12 may be partially or entirely included in RFIC 3.

The input end of low-noise amplifier 21 is connected to filter 44. The output end of low-noise amplifier 21 is connected to radio frequency output terminal 121. Low-noise amplifier 21 can amplify a received signal that has passed through filter 44, by using power supplied from a power source (not illustrated).

The input end of low-noise amplifier 22 is connected to filter 45. The output end of low-noise amplifier 22 is connected to radio frequency output terminal 122. Low-noise amplifier 22 can amplify a received signal that has passed through filter 45, by using power supplied from a power source (not illustrated).

The input end of low-noise amplifier 23 is connected to filter 46. The output end of low-noise amplifier 23 is connected to radio frequency output terminal 123. Low-noise amplifier 23 can amplify a received signal that has passed through filter 46, by using power supplied from a power source (not illustrated).

The input end of low-noise amplifier 24 is connected to filter 47. The output end of low-noise amplifier 24 is connected to radio frequency output terminal 124. Low-noise amplifier 24 can amplify a received signal that has passed through filter 47, by using power supplied from a power source (not illustrated).

Low-noise amplifiers 21 to 24 can include field effect transistors (FETs), and can be manufactured using semiconductor material. As the semiconductor material, for example, monocrystal silicon, gallium nitride (GaN), or a silicon carbide (SiC) can be used. Note that amplifier transistors of low-noise amplifiers 21 to 24 are not limited to FETs. For example, one or more or all of low-noise amplifiers 21 to 24 may each include a bipolar transistor.

Note that one or more or all of low-noise amplifiers 21 to 24 may not be partially or entirely included in radio frequency circuit 1A. In this case, low-noise amplifier 21 may be partially or entirely connected between radio frequency output terminal 121 and RFIC 3, low-noise amplifier 22 may be partially or entirely connected between radio frequency output terminal 122 and RFIC 3, low-noise amplifier 23 may be partially or entirely connected between radio frequency output terminal 123 and RFIC 3, and low-noise amplifier 24 may be partially or entirely connected between radio frequency output terminal 124 and RFIC 3. One or more or all of low-noise amplifiers 21 to 24 may be partially or entirely included in RFIC 3.

Filter 41 is an example of a first filter and has a passband that includes a transmission (n256-Tx) band of n256 (an example of a first NTN band) for 5G NR. In the present embodiment, the n256-Tx band is used as a first frequency band. Filter 41 is connected between switches 51 and 52. Specifically, one end of filter 41 is connected to terminal 512 of switch 51, and another end of filter 41 is connected to terminal 523 of switch 52.

Filter 42 is an example of a second filter and has a passband that includes a transmission (n255-Tx) band of n255 (an example of a second NTN band) for 5G NR and a transmission (n254-Tx) band of n254 (an example of a third NTN band) for 5G NR. In the present embodiment, the n255-Tx band is used as a second frequency band. Filter 42 is connected between switches 51 and 52. Specifically, one end of filter 42 is connected to terminal 512 of switch 51, and another end of filter 42 is connected to terminal 524 of switch 52.

Filter 43 is an example of a third filter and has a passband that includes a transmission (Band 1/n1-Tx) band of Band 1 for LTE or n1 for 5G NR (an example of a first TN band). In the present embodiment, the Band 1/n1-Tx band is used as a third frequency band. Filter 43 is connected between switches 51 and 52. Specifically, one end of filter 43 is connected to terminal 513 of switch 51, and another end of filter 43 is connected to terminal 525 of switch 52.

Filter 44 is an example of a fourth filter and has a passband that includes a receiving (Band 3/n3-Rx) band of Band 3 for LTE or n3 for 5G NR (an example of a second TN band). In the present embodiment, the Band 3/n3-Rx band is used as a fourth frequency band. Filter 44 is connected between switch 51 and low-noise amplifier 21. Specifically, one end of filter 44 is connected to terminal 513 of switch 51, and another end of filter 44 is connected to low-noise amplifier 21.

Filter 45 is an example of a fifth filter and has a passband that includes a receiving (n256-Rx) band of n256 (an example of the first NTN band) for 5G NR. Filter 45 is connected between switch 51 and low-noise amplifier 22. Specifically, one end of filter 45 is connected to terminal 512 of switch 51, and another end of filter 45 is connected to low-noise amplifier 22.

Filter 46 is an example of a sixth filter and has a passband that includes a receiving (n255-Rx) band of n255 (an example of the second NTN band) for 5G NR. Filter 46 is connected between switch 51 and low-noise amplifier 23. Specifically, one end of filter 46 is connected to terminal 512 of switch 51, and another end of filter 46 is connected to low-noise amplifier 23.

Filter 47 is an example of a seventh filter and has a passband that includes a receiving (n254-Rx) band of n254 (an example of the third NTN band) for 5G NR. Filter 47 is connected between switch 51 and low-noise amplifier 24. Specifically, one end of filter 47 is connected to terminal 512 of switch 51, and another end of filter 47 is connected to low-noise amplifier 24.

Similarly to filters 31 to 34 according to Embodiment 1, a SAW filter, a BAW filter, an LC resonator filter, a dielectric resonator filter, or a combination of any of these may be used as each of filters 41 to 47, and furthermore, filters 41 to 47 are not limited to these.

Switch 51 is an example of a first switch, and is connected between antenna connection terminal 100 and filters 41 to 47. Specifically, switch 51 includes terminals 511 to 513. Terminal 511 is an example of a first terminal, and is connected to antenna connection terminal 100. Terminal 512 is an example of a second terminal, and is connected to filters 41, 42, and 45 to 47. Terminal 513 is an example of a third terminal, and is connected to filters 43 and 44.

With such a connection configuration, switch 51 can connect terminal 511 exclusively to terminal 512 or can connect terminal 511 exclusively to terminal 513, based on a control signal from RFIC 3, for example. Stated differently, terminal 511 is prohibited from being simultaneously connected to terminals 512 and 513 in switch 51. Switch 51 includes an SPDT switch circuit, for example.

Switch 52 is an example of a second switch, and is connected between (i) power amplifiers 11 and 12 and (ii) filters 41 to 43. Specifically, switch 52 includes terminals 521 to 525. Terminal 521 is an example of a first terminal, and is connected to power amplifier 11. Terminal 522 is an example of a second terminal, and is connected to power amplifier 12. Terminal 523 is an example of a third terminal, and is connected to filter 41. Terminal 524 is an example of a fourth terminal, and is connected to filter 42. Terminal 525 is an example of a fifth terminal, and is connected to filter 43.

With such a connection configuration, switch 52 can connect terminals 521 and 522 each exclusively to terminal 523, 524, or 525, based on a control signal from RFIC 3, for example. Thus, switch 52 connects terminal 521 to any terminal among terminals 523 to 525, and connects terminal 522 to any remaining terminal among terminals 523 to 525. Switch 52 includes a multi-connection type switch circuit, for example.

Switches 51 and 52 may be mounted on a single semiconductor integrated circuit that includes a plurality of MOSFETs, for example, but the method for mounting switches 51 and 52 is not limited thereto.

Note that radio frequency circuit 1A is not limited to the configuration illustrated in FIG. 4. For example, radio frequency circuit 1A may further include one or more filters. As the one or more filters, for example, a filter having a passband that includes the receiving band of Band 1 for LTE or n1 for 5G NR, a filter having a passband that includes the transmission band of Band 3 for LTE or n3 for 5G NR, a filter having a passband that includes the transmission-receiving band of Band 34 for LTE or n34 for 5G NR, a filter having a passband that includes the transmission-receiving band of Band 40 for LTE or n40 for 5G NR, or any combinations thereof. At this time, one or more filters may be connected to terminal 513 of switch 51.

As the one or more filters, for example, a filter having a passband that includes the transmission band of Band 2 for LTE or n2 for 5G NR, a filter having a passband that includes the receiving band of Band 2 for LTE or n2 for 5G NR, a filter having a passband that includes the transmission band of Band 66 for LTE or n66 for 5G NR, a filter having a passband that includes the receiving band of Band 66 for LTE or n66 for 5G NR, or any combinations thereof. At this time, the one or more filters may be connected to a terminal/terminals not illustrated and different from terminals 512 and 513 of switch 51.

### [2.2 Advantageous Effects and Others]

As described above, radio frequency circuit 1A according to the present embodiment includes: filter 41 having a passband that includes a first frequency band that is at least one of a transmission band or a receiving band of a first Non-Terrestrial Network (NTN) band; filter 42 having a passband that includes a second frequency band that is at least one of a transmission band or a receiving band of a second NTN band; filter 43 having a passband that includes a third frequency band that is at least one of a transmission band or a receiving band of a first Terrestrial Network (TN) band; and switch 51 that includes terminal 511 connected to antenna connection terminal 100, terminal 512 connected to filters 41 and 42, and terminal 513 connected to filter 43. The third frequency band at least partially overlaps a frequency gap between the first frequency band and the second frequency band.

According to this, advantageous effects equivalent to those yielded by radio frequency circuit 1 according to Embodiment 1 above can be yielded.

For example, radio frequency circuit 1A according to the present embodiment may further include: power amplifiers 11 and 12; and switch 52 that includes terminal 521 connected to power amplifier 11, terminal 522 connected to power amplifier 12, terminal 523 connected to filter 41, terminal 524 connected to filter 42, and terminal 525 connected to filter 43.

According to this, radio frequency circuit 1A can amplify transmission signals in three bands by using two power amplifiers 11 and 12, which can contribute to reduction in the size of communication device 5A.

For example, radio frequency circuit 1A according to the present embodiment may further include: filter 45 having a passband that includes the receiving band of the first NTN band.

According to this, radio frequency circuit 1A can support reception of radio frequency signals in the first NTN band in addition to transmission of radio frequency signals in the first NTN band.

For example, radio frequency circuit 1A according to the present embodiment may further include: filter 46 having a passband that includes the receiving band of the second NTN band.

According to this, radio frequency circuit 1A can support reception of radio frequency signals in the second NTN band in addition to transmission of radio frequency signals in the second NTN band.

For example, in radio frequency circuit 1A according to the present embodiment, the passband of filter 42 may further include a transmission band of a third NTN band.

According to this, radio frequency circuit 1A can support transmission of radio frequency signals in the third NTN band. At this time, single filter 42 can support transmission of radio frequency signals in the second NTN band and the third NTN band, which can contribute to reduction in the size of communication device 5A.

For example, in radio frequency circuit 1A according to the present embodiment, the first NTN band may be n256 for 5th Generation New Radio (5G NR), the second NTN band may be n255 for 5G NR, and the third NTN band may be n254 for 5G NR.

According to this, radio frequency circuit 1A can use n256, n255, and n254 for 5G NR to transmit radio frequency signals in NTNs.

For example, radio frequency circuit 1A according to the present embodiment may further include: filter 47 having a passband that includes a receiving band of the third NTN band.

According to this, radio frequency circuit 1A can support reception of radio frequency signals in the third NTN band in addition to transmission of radio frequency signals in the third NTN band.

### Embodiment 3

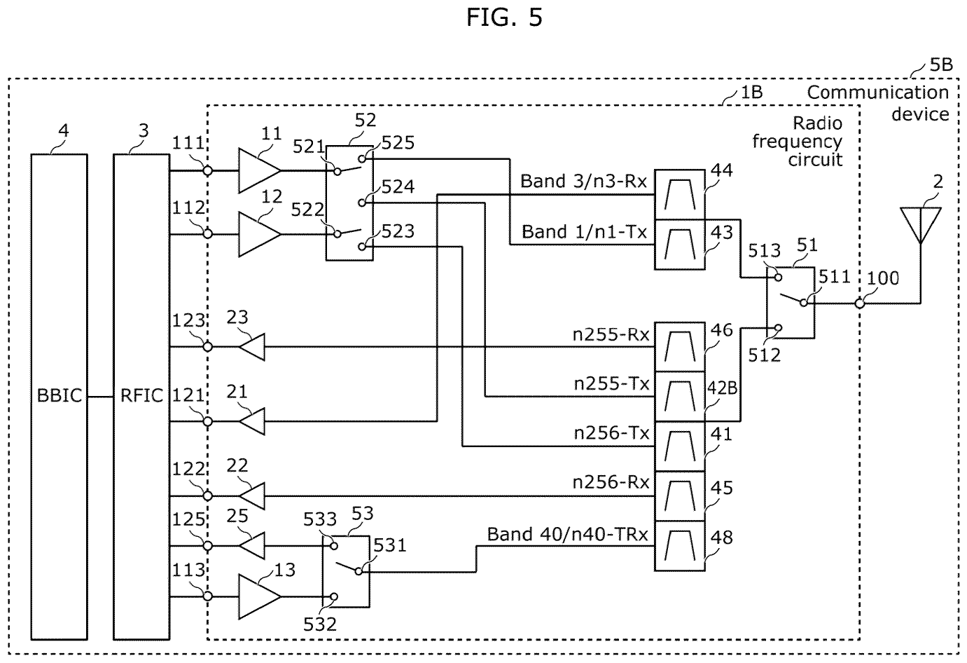

Next, Embodiment 3 is to be described. The present embodiment is mainly different from Embodiment 2 described above in that a filter for an NTN band and a filter for a TN band are connected to the same terminal of a switch. In the following, the present embodiment is to be described with reference to FIG. 5, focusing on different points from Embodiment 2 above. FIG. 5 illustrates a circuit configuration of communication device 5B according to the present embodiment.

Note that FIG. 5 illustrates an exemplary circuit configuration, and communication device 5B and radio frequency circuit 1B may be implemented using any of various types of circuit implementations and circuit technologies. Thus, the description of communication device 5B and radio frequency circuit 1B provided below should not be interpreted in a limited manner.

Since communication device 5B according to the present embodiment is the same as communication device 5 according to Embodiment 1 except that radio frequency circuit 1B is included instead of radio frequency circuit 1, and thus description of elements of communication device 5B other than radio frequency circuit 1B is omitted.

### [3.1 Circuit Configuration of Radio Frequency Circuit 1B]

Radio frequency circuit 1B according to the present embodiment includes power amplifiers 11 to 13, low-noise amplifiers 21 to 23 and 25, filters 41, 42B, 43 to 46, and 48, switches 51 to 53, antenna connection terminal 100, radio frequency input terminals 111 to 113, and radio frequency output terminals 121 to 123 and 125.

Radio frequency input terminal 113 is an external connection terminal of radio frequency circuit 1B and can receive transmission signals from RFIC 3. Specifically, radio frequency input terminal 113 is connected to RFIC 3 outside radio frequency circuit 1B and is connected to power amplifier 13 inside radio frequency circuit 1B.

Radio frequency output terminal 125 is an external connection terminal of radio frequency circuit 1B and can supply received signals to RFIC 3. Specifically, radio frequency output terminal 125 is connected to RFIC 3 outside radio frequency circuit 1B and is connected to low-noise amplifier 25 inside radio frequency circuit 1B.

Power amplifier 13 is an example of a third power amplifier. The input end of power amplifier 13 is connected to radio frequency input terminal 113. The output end of power amplifier 13 is connected to filter 48 via switch 53. Power amplifier 13 can amplify radio frequency signals received via radio frequency input terminal 113, using power supplied from a power supply (not illustrated).

Similarly to power amplifier 11 according to Embodiment 2, power amplifier 13 can include an HBT and can be manufactured by using semiconductor material. Note that an amplifier transistor of power amplifier 13 is not limited to an HBT.

Note that power amplifier 13 may not be partially or entirely included in radio frequency circuit 1B. In this case, power amplifier 13 may be partially or entirely connected between RFIC 3 and radio frequency input terminal 113 or may be partially or entirely included in RFIC 3.

The input end of low-noise amplifier 25 is connected to filter 48 via switch 53. The output end of low-noise amplifier 25 is connected to radio frequency output terminal 125. Low-noise amplifier 25 can amplify a received signal that has passed through filter 48, by using power supplied from a power source (not illustrated).

Similarly to low-noise amplifiers 21 to 24 according to Embodiment 2, low-noise amplifier 25 can include an FET and can be manufactured by using semiconductor material. Note that an amplifier transistor of low-noise amplifier 25 is not limited to an FET.

Note that low-noise amplifier 25 may not be partially or entirely included in radio frequency circuit 1B. In this case, low-noise amplifier 25 may be partially or entirely connected between radio frequency output terminal 125 and RFIC 3 or may be partially or entirely included in RFIC 3.

Filter 42B is an example of a second filter and has a passband that includes a transmission (n255-Tx) band of n255 (an example of a second NTN band) for 5G NR. Filter 42B is connected between switches 51 and 52. Specifically, one end of filter 42B is connected to terminal 512 of switch 51, and another end of filter 42B is connected to terminal 524 of switch 52.

Filter 48 is an example of an eighth filter and has a passband that includes a transmission-receiving (Band 40/n40-TRx) band of Band 40 for LTE or n40 for 5G NR (an example of a third TN band). Filter 48 is connected between switches 51 and 53. Specifically, one end of filter 48 is connected to terminal 512 of switch 51, and another end of filter 48 is connected to terminal 531 of switch 53.

The Band 40/n40-TRx band included in the passband of filter 48 does not overlap the frequency gap between the first frequency band (the n256-Tx band) and the second frequency band (the n255-Tx band). Furthermore, the Band 40/n40-TRx band does not overlap the frequency gap between the n256-Rx band and the n255-Rx band either. Thus, the passband of filter 48 does not overlap the frequency gap between the highest passband (the passband of filter 45) and the lowest passband (the passband of filter 46), among the passbands of the other filters connected to terminal 512 of switch 51.

Note that the passband of filter 48 may include the band(s) stated below as at least one of the transmission band or the receiving band of the third TN band, instead of the Band 40/n40-TRx band.
(1) The transmission band and/or the receiving band of Band 11 for LTE
(2) The transmission band and/or the receiving band of Band 21 for LTE
(3) The receiving band of Band 32 for LTE
(4) The transmission band and/or the receiving band of Band 74 for LTE
(5) The receiving band of Band 75 for LTE
(6) The receiving band of Band 76 for LTE
(7) The transmission band and/or the receiving band of n74 for 5G NR
(8) The receiving band of n75 for 5G NR
(9) The receiving band of n76 for 5G NR
(10) The transmission-receiving band of Band 40 for LTE
(11) The transmission-receiving band of n40 for 5G NR

Similarly to filters 31 to 34 according to Embodiment 1, a SAW filter, a BAW filter, an LC resonator filter, a dielectric resonator filter, or a combination of any of these may be used as each of filters 42B and 48, and furthermore, filters 42B and 48 are not limited to these.

Switch 53 is an example of a third switch, and is connected between (i) filter 48 and (ii) power amplifier 13 and low-noise amplifier 25. Specifically, switch 53 includes terminals 531 to 533. Terminal 531 is an example of a first terminal, and is connected to filter 48. Terminal 532 is an example of a second terminal, and is connected to power amplifier 13. Terminal 533 is an example of a third terminal, and is connected to low-noise amplifier 25.

With such a connection configuration, switch 53 can connect terminal 531 exclusively to terminal 532 or can connect terminal 531 exclusively to terminal 533, based on a control signal from RFIC 3, for example. Stated differently, terminal 531 is prohibited from being simultaneously connected to terminals 532 and 533 in switch 53. Switch 53 includes an SPDT switch circuit, for example.

Switches 51 to 53 may be mounted on a single semiconductor integrated circuit that includes a plurality of MOSFETs, for example, but the method for mounting switches 51 to 53 is not limited thereto.

### [3.2 Advantageous Effects and Others]

As described above, radio frequency circuit 1B according to the present embodiment includes: filter 41 having a passband that includes a first frequency band that is at least one of a transmission band or a receiving band of a first Non-Terrestrial Network (NTN) band; filter 42B having a passband that includes a second frequency band that is at least one of a transmission band or a receiving band of a second NTN band; filter 43 having a passband that includes a third frequency band that is at least one of a transmission band or a receiving band of a first Terrestrial Network (TN) band; and switch 51 that includes terminal 511 connected to antenna connection terminal 100, terminal 512 connected to filters 41 and 42B, and terminal 513 connected to filter 43. The third frequency band at least partially overlaps a frequency gap between the first frequency band and the second frequency band.

According to this, advantageous effects equivalent to those yielded by radio frequency circuit 1 according to Embodiment 1 described above can be yielded.

For example, radio frequency circuit 1B according to the present embodiment may further include: filter 48 connected to terminal 512 of switch 51 and having a passband that includes at least one of a transmission band or a receiving band of a third TN band. The at least one of the transmission band or the receiving band of the third TN band may not overlap the frequency gap between the first frequency band and the second frequency band.

According to this, filter 48 having a passband that includes at least one of the transmission band or the receiving band of the third TN band can be connected to terminal 512 that is the same as the terminal to which filters 41 and 42B for the NTN bands are connected. Also in this case, at least one of the transmission band or the receiving band of the third TN band does not overlap the frequency gap between the first frequency band and the second frequency band, and thus the steepness of attenuation characteristics at at least one of the two edges of the passband of each of filters 31 and 32 can be made less, and resistance loss of filters 31 and 32 and/or the sizes thereof can be reduced.

For example, in radio frequency circuit 1B according to the present embodiment, the first NTN band may be n256 for 5th Generation New Radio (5G NR), the second NTN band may be n255 or n254 for 5G NR, and the third TN band may be Band 40 for Long Term Evolution (LTE) or n40 for 5G NR.

According to this, radio frequency circuit 1B can further use Band 40 for LTE or n40 for 5G NR to transmit and/or receive radio frequency signals in TNs.

For example, radio frequency circuit 1B according to the present embodiment may further include: power amplifier 13; low-noise amplifier 25; and switch 53 that includes terminal 531 connected to filter 48, terminal 532 connected to power amplifier 13, and terminal 533 connected to low-noise amplifier 25.

According to this, a transmission signal and a received signal that pass through filter 48 can be amplified, and filter 48 can be used for both transmitting and receiving TDD signals.

### Other Embodiments

The above has described radio frequency circuits according to the present disclosure, based on the embodiments, yet the radio frequency circuits according to the present disclosure are not limited to the above embodiments. The present disclosure also encompasses another embodiment achieved by combining arbitrary elements in the above embodiments, variations resulting from applying, to the embodiments, various modifications that may be conceived by those skilled in the art within a range that does not depart from the scope of the present disclosure, and various devices that each include the radio frequency circuit.

For example, in the circuit configurations of the radio frequency circuits according to the above embodiments, another circuit element and a line, for instance, may be provided between circuit elements and paths connecting signal paths, which are disclosed in the drawings. For example, an impedance matching circuit may be provided between (i) a power amplifier and/or a low-noise amplifier and (ii) a filter. Furthermore, for example, an impedance matching circuit may be provided between a filter and an antenna connection terminal. An impedance matching circuit can include an inductor and/or a capacitor, for example, but is not limited to such a configuration.

The following states features of the radio frequency circuits described based on the above embodiments.

<1>

A radio frequency circuit including:
a first filter having a passband that includes a first frequency band that is at least one of a transmission band or a receiving band of a first Non-Terrestrial Network (NTN) band;
a second filter having a passband that includes a second frequency band that is at least one of a transmission band or a receiving band of a second NTN band;
a third filter having a passband that includes a third frequency band that is at least one of a transmission band or a receiving band of a first Terrestrial Network (TN) band; and
a first switch that includes a first terminal connected to an antenna connection terminal, a second terminal connected to the first filter and the second filter, and a third terminal connected to the third filter,
wherein the third frequency band at least partially overlaps a frequency gap between the first frequency band and the second frequency band.
   <2>

The radio frequency circuit according to <1>,
wherein the first switch is configured to connect the first terminal exclusively to the second terminal or to connect the first terminal exclusively to the third terminal.
   <3>

The radio frequency circuit according to <1> or <2>,
wherein the first frequency band is the transmission band of the first NTN band,
the second frequency band is the transmission band of the second NTN band, and
the third frequency band is the transmission band of the first TN band.
   <4>

The radio frequency circuit according to <3>,
wherein the first NTN band is n256 for 5th Generation New Radio (5G NR),
the second NTN band is n255 or n254 for 5G NR, and
the first TN band is Band 1 for Long Term Evolution (LTE) or n1 for 5G NR.
   <5>

The radio frequency circuit according to <3> or <4>, further including:
a first power amplifier;
a second power amplifier; and
a second switch that includes a first terminal connected to the first power amplifier, a second terminal connected to the second power amplifier, a third terminal connected to the first filter, a fourth terminal connected to the second filter, and a fifth terminal connected to the third filter.
   <6>

The radio frequency circuit according to any one of <3> to <5>, further including:
a fourth filter connected to the third terminal of the first switch and having a passband that includes a fourth frequency band that is at least one of a transmission band or a receiving band of a second TN band,
wherein the fourth frequency band at least partially overlaps the frequency gap between the first frequency band and the second frequency band, and
the frequency gap between the first frequency band and the second frequency band is wider than a frequency gap between the third frequency band and the fourth frequency band.
   <7>

The radio frequency circuit according to <6>,
wherein the fourth frequency band is the receiving band of the second TN band.
   <8>

The radio frequency circuit according to <7>,
wherein the first NTN band is n256 for 5th Generation New Radio (5G NR),
the second NTN band is n255 or n254 for 5G NR,
the first TN band is Band 1 for Long Term Evolution (LTE) or n1 for 5G NR, and
the second TN band is Band 3 for LTE or n3 for 5G NR.
   <9>

The radio frequency circuit according to any one of <3> to <8>, further including:
a fifth filter having a passband that includes the receiving band of the first NTN band.
   <10>

The radio frequency circuit according to <3> to <9>, further including:
a sixth filter having a passband that includes the receiving band of the second NTN band.
   <11>

The radio frequency circuit according to any one of <3> to <10>,
wherein the passband of the second filter further includes a transmission band of a third NTN band.
   <12>

The radio frequency circuit according to <11>,
wherein the first NTN band is n256 for 5th Generation New Radio (5G NR),
the second NTN band is n255 for 5G NR, and
the third NTN band is n254 for 5G NR.
   <13>

The radio frequency circuit according to <12>, further including:
a seventh filter having a passband that includes a receiving band of the third NTN band.
   <14>

The radio frequency circuit according to any one of <3> to <8>, further including:
an eighth filter connected to the second terminal of the first switch and having a passband that includes at least one of a transmission band or a receiving band of a third TN band,
wherein the at least one of the transmission band or the receiving band of the third TN band does not overlap the frequency gap between the first frequency band and the second frequency band.
   <15>

The radio frequency circuit according to <14>,
wherein the first NTN band is n256 for 5th Generation New Radio (5G NR),
the second NTN band is n255 or n254 for 5G NR, and
the third TN band is Band 40 for Long Term Evolution (LTE) or n40 for 5G NR.
   <16>

The radio frequency circuit according to <14> or <15>, further including:
a third power amplifier;
a low-noise amplifier; and
a third switch that includes a first terminal connected to the eighth filter, a second terminal connected to the third power amplifier, and a third terminal connected to the low-noise amplifier.
   <17>

The radio frequency circuit according to <1> or <2>,
wherein the first frequency band is the transmission band of the first NTN band,
the second frequency band is the transmission band of the second NTN band, and
the third frequency band is the receiving band of the first TN band.
   <18>

The radio frequency circuit according to <17>,
wherein the first NTN band is n256 for 5th Generation New Radio (5G NR),
the second NTN band is n255 or n254 for 5G NR, and
the first TN band is Band 3 for Long Term Evolution (LTE) or n3 for 5G NR.
   <19>

A radio frequency circuit including:
a first filter having a passband that includes a first frequency band that is a transmission band of a Non-Terrestrial Network (NTN) band;
a second filter having a passband that includes a second frequency band that is a receiving band of the NTN band;
a third filter having a passband that includes a third frequency band that is at least one of a transmission band or a receiving band of a Terrestrial Network (TN) band; and
a switch that includes a first terminal connected to an antenna connection terminal, a second terminal connected to the first filter and the second filter, and a third terminal connected to the third filter,
wherein the third frequency band at least partially overlaps a frequency gap between the first frequency band and the second frequency band.
   <20>

The radio frequency circuit according to <19>,
wherein the NTN band is n256 for 5th Generation New Radio (5G NR), and
the TN band is a band selected from among Band 1, Band 34, and Band 66 for Long Term Evolution (LTE) and n1, n34, and n66 for 5G NR.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is widely applicable to communication devices such as mobile phones as radio frequency circuits disposed in front end portions.

1. A radio frequency circuit comprising:
a first filter having a passband that includes a first frequency band that is at least one of a transmission band or a receiving band of a first Non-Terrestrial Network (NTN) band;
a second filter having a passband that includes a second frequency band that is at least one of a transmission band or a receiving band of a second NTN band;
a third filter having a passband that includes a third frequency band that is at least one of a transmission band or a receiving band of a first Terrestrial Network (TN) band; and
a first switch that includes a first terminal connected to an antenna connection terminal, a second terminal connected to the first filter and the second filter, and a third terminal connected to the third filter,
wherein the third frequency band at least partially overlaps a frequency gap between the first frequency band and the second frequency band.

2. The radio frequency circuit according to claim 1,
wherein the first switch is configured to connect the first terminal exclusively to the second terminal or to connect the first terminal exclusively to the third terminal.

3. The radio frequency circuit according to claim 1,
wherein the first frequency band is the transmission band of the first NTN band,
the second frequency band is the transmission band of the second NTN band, and
the third frequency band is the transmission band of the first TN band.

4. The radio frequency circuit according to claim 3,
wherein the first NTN band is n256 for 5th Generation New Radio (5G NR),
the second NTN band is n255 or n254 for 5G NR, and
the first TN band is Band 1 for Long Term Evolution (LTE) or n1 for 5G NR.

5. The radio frequency circuit according to claim 3, further comprising:
a first power amplifier;
a second power amplifier; and
a second switch that includes a first terminal connected to the first power amplifier, a second terminal connected to the second power amplifier, a third terminal connected to the first filter, a fourth terminal connected to the second filter, and a fifth terminal connected to the third filter.

6. The radio frequency circuit according to claim 3, further comprising:
a fourth filter connected to the third terminal of the first switch and having a passband that includes a fourth frequency band that is at least one of a transmission band or a receiving band of a second TN band,
wherein the fourth frequency band at least partially overlaps the frequency gap between the first frequency band and the second frequency band, and
the frequency gap between the first frequency band and the second frequency band is wider than a frequency gap between the third frequency band and the fourth frequency band.

7. The radio frequency circuit according to claim 6,
wherein the fourth frequency band is the receiving band of the second TN band.

8. The radio frequency circuit according to claim 7,
wherein the first NTN band is n256 for 5th Generation New Radio (5G NR),
the second NTN band is n255 or n254 for 5G NR,
the first TN band is Band 1 for Long Term Evolution (LTE) or n1 for 5G NR, and
the second TN band is Band 3 for LTE or n3 for 5G NR.

9. The radio frequency circuit according to claim 3, further comprising:
a fifth filter having a passband that includes the receiving band of the first NTN band.

10. The radio frequency circuit according to claim 3, further comprising:
a sixth filter having a passband that includes the receiving band of the second NTN band.

11. The radio frequency circuit according to claim 3,
wherein the passband of the second filter further includes a transmission band of a third NTN band.

12. The radio frequency circuit according to claim 11,
wherein the first NTN band is n256 for 5th Generation New Radio (5G NR),
the second NTN band is n255 for 5G NR, and
the third NTN band is n254 for 5G NR.

13. The radio frequency circuit according to claim 12, further comprising:
a seventh filter having a passband that includes a receiving band of the third NTN band.

14. The radio frequency circuit according to claim 3, further comprising:
an eighth filter connected to the second terminal of the first switch and having a passband that includes at least one of a transmission band or a receiving band of a third TN band,
wherein the at least one of the transmission band or the receiving band of the third TN band does not overlap the frequency gap between the first frequency band and the second frequency band.

15. The radio frequency circuit according to claim 14,
wherein the first NTN band is n256 for 5th Generation New Radio (5G NR),
the second NTN band is n255 or n254 for 5G NR, and
the third TN band is Band 40 for Long Term Evolution (LTE) or n40 for 5G NR.

16. The radio frequency circuit according to claim 14, further comprising:
a third power amplifier;
a low-noise amplifier; and
a third switch that includes a first terminal connected to the eighth filter, a second terminal connected to the third power amplifier, and a third terminal connected to the low-noise amplifier.

17. The radio frequency circuit according to claim 1,
wherein the first frequency band is the transmission band of the first NTN band,
the second frequency band is the transmission band of the second NTN band, and
the third frequency band is the receiving band of the first TN band.

18. The radio frequency circuit according to claim 17,
wherein the first NTN band is n256 for 5th Generation New Radio (5G NR),
the second NTN band is n255 or n254 for 5G NR, and
the first TN band is Band 3 for Long Term Evolution (LTE) or n3 for 5G NR.

19. A radio frequency circuit comprising:
a first filter having a passband that includes a first frequency band that is a transmission band of a Non-Terrestrial Network (NTN) band;
a second filter having a passband that includes a second frequency band that is a receiving band of the NTN band;
a third filter having a passband that includes a third frequency band that is at least one of a transmission band or a receiving band of a Terrestrial Network (TN) band; and
a switch that includes a first terminal connected to an antenna connection terminal, a second terminal connected to the first filter and the second filter, and a third terminal connected to the third filter,
wherein the third frequency band at least partially overlaps a frequency gap between the first frequency band and the second frequency band.

20. The radio frequency circuit according to claim 19,
wherein the NTN band is n256 for 5th Generation New Radio (5G NR), and
the TN band is a band selected from among Band 1, Band 34, and Band 66 for Long Term Evolution (LTE) and n1, n34, and n66 for 5G NR.
